(19) United States
(12) Patent Application Publication
(10) Pub. No.: US 2025/0155881 A1
(43) Pub. Date: May 15, 2025

(54) PRODUCTION MANAGEMENT SYSTEM, PRODUCTION MANAGEMENT METHOD, AND PROGRAM

(71) Applicant: OMRON Corporation, Kyoto-shi, KYOTO (JP)

(72) Inventors: Hiroyuki MORI, Kyoto-shi, KYOTO (JP); Mayuko TANAKA, Kyoto-shi, KYOTO (JP); Katsuki NAKAJIMA, Kyoto-shi, KYOTO (JP)

(21) Appl. No.: 18/834,281

(22) PCT Filed: Feb. 6, 2023
(86) PCT No.: PCT/JP2023/003840

§ 371 Date: Jul. 30, 2024

(30) Foreign Application Priority Data
Feb. 18, 2022 (JP) 2022-024111

(51) Int. Cl. G05B 19/418; G06Q 10/0639; G06Q 50/04

(52) U.S. Cl. CPC G05B 19/41875; G06Q 10/06395; G06Q 50/04

(57) ABSTRACT

The production management system (1) is characterized by comprising: a performance value calculation unit (110a) that calculates a production performance value, which is a performance value of an index relating to productivity or quality of a product on the production line (10); and an actual ability value calculation unit (110a) that calculates an actual production ability value, which is an actual ability value of the index relating to productivity or quality of the product on the production line. The actual production ability value is the index relating to productivity or quality of the product, which is calculated by eliminating, from index data relating to productivity or quality of the product on the production line (10), the index data corresponding to statistical outliers in distribution of the production performance values, and/or the index data affected by a predetermined condition change in the production line.

### TECHNICAL FIELD

The present invention relates to a production management system, a production management method, and a program for managing production in a production line of a product.

### BACKGROUND ART

In a production line of a product, a product inspection device is disposed in an intermediate process or a final process of the production line, and defect detection, defective product sorting, and the like are performed. For example, in a production line of a component mounting board, generally, a device (printing device) that prints cream solder on a printed wiring board, a device (mounting device) that mounts a component on the board on which the cream solder is printed, and a device (reflow device) that heats the board after component mounting to solder the component to the board are included. Then, the product inspection device disposed after each production device inspects whether the work in each device is correctly performed as scheduled.

Furthermore, in the above-described production line, a production management system that collects information from each manufacturing device and inspection device and comprehensively manages a defect rate, a production amount, and the like is operated, which contributes to improvement of productivity as the entire production line.

In the production management system as described above, there is a case where a function of aggregating data related to production of a product in a certain period and outputting the data as a report is required (See, for example, Patent Documents 1 and 2). In this report function, there has been a case where an aggregation report for each production line, each manufacturing device, each product, and each KPI is provided. However, for example, in many cases, an ideal value calculated on a desk based on a business plan is compared with a performance value including results of various troubles, and a capability value of a production line is unclear. Therefore, it cannot be said that it is possible to quickly grasp a location and a scale of a problem to be preferentially solved. Furthermore, the validity of a target value and the loss due to the deviation between the capability value and the performance value are unclear, and it cannot be said that efficient measures for improving the productivity of the production line can be taken.

### PRIOR ART DOCUMENT

### Patent Documents

Patent Document 1: Japanese Unexamined Patent Publication No. 2003-187069
Patent Document 2: Japanese Unexamined Patent Publication No. 2003-122420

### SUMMARY OF THE INVENTION

### Problems to be Solved by the Invention

The present invention has been made in view of the above circumstances, and an object of the present invention is to provide a technique that makes it possible to more clearly recognize a preferential improvement point of a production line.

### Means for Solving the Problem

In order to achieve the above-described object, the present disclosure adopts the following configuration. That is, a production management system related to a production line including a single or a plurality of manufacturing devices and a single or a plurality of inspection devices, in which a manufacturing process and an inspection process of a product by the manufacturing devices and the inspection devices are executed, the production management system including: a performance value calculation unit configured to calculate a production performance value that is a performance value of an index related to productivity or quality of the product in the production line; and a capability value calculation unit configured to calculate, based on the performance value, a production capability value that is a capability value of an index related to productivity or quality of the product in the production line, in which the production capability value is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

According to this, it is possible to acquire: the production performance value that is the performance value of the index related to productivity or quality of the product in the production line; and the production capability value that is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

As a result, by comparing the production performance value with the production capability value, it is possible to more easily grasp an index of productivity or quality of the production line that can be improved, and improve the index to improve the productivity or quality. Note that, in the present disclosure, the predetermined condition change in the production line may include a change corresponding to a so-called 4M fluctuation. Furthermore, in the present disclosure, it is possible to more accurately obtain the capability value of a target production line by excluding data that has become a statistical outlier in the production performance value for some reason or data related to a sudden condition change in the process. Moreover, it is possible to bring the performance value close to the capability value by eliminating or improving a predetermined condition change in the production line that has affected the data of the index excluded in the calculation of the capability value.

Furthermore, in the present disclosure, the predetermined condition

change may include a planned condition change planned in advance for the production line and an accidental condition change accidentally occurring in the production line, the performance value calculation unit may calculate the production performance value by excluding, from data of the index related to productivity or quality of the product in the production line, data of the index corresponding to a statistical outlier in a distribution of the production performance value and affected by the planned condition change in the production line, and the capability value calculation unit may calculate the production capability value by further excluding, from data of the index related to productivity or quality of the product used for calculation of the production performance value, data of the index corresponding to a statistical outlier in a distribution of the production performance value and affected by the accidental condition change in the production line. The production performance value can be calculated by excluding the influence of the planned condition change scheduled in advance, and further, the production capability value can be calculated by excluding the influence of the accidental condition change. According to this, it is possible to calculate the production performance value and the production capability value in a manner that facilitates factor analysis.

Furthermore, in the present disclosure, the index related to productivity or quality of the product in the production line may include at least one of a production amount of the product per predetermined time, a manufacturing takt time of the product, and an error rate of the product. By using such a direct index, it is possible to more clearly grasp a preferential measure for increasing the production amount.

Furthermore, the production management system may further include a result report unit configured to create a result report capable of comparing the production performance value and the production capability value in a predetermined period. In this way, it is possible to more clearly show a preferential measure for increasing the production amount to a manager or the like having a right to make a decision related to the production line.

Furthermore, the production management system may further include a result report unit configured to create a result report capable of comparing the production performance value and the production capability value in a predetermined period, in which the result report unit may report contents of the accidental condition change related to the data of the index excluded when the capability value calculation unit calculates the production capability value. It is possible to clarify the cause of a difference between the production performance value and the production capability value, and to clearly grasp a countermeasure for bringing the production performance value close to a production target value.

Furthermore, the present disclosure may be a production management method in a production line including a single or a plurality of manufacturing devices and a single or a plurality of inspection devices, in which a manufacturing process and an inspection process of a product by the manufacturing devices and the inspection devices are executed, the production management method including: a performance value calculation process of calculating a production performance value that is a performance value of an index related to productivity or quality of the product in the production line; and a capability value calculation process of calculating, based on the performance value, a production capability value that is a capability value of an index related to productivity or quality of the product in the production line, in which the production capability value is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

Furthermore, the present disclosure may be the production management method described above, in which the predetermined condition change includes a planned condition change planned in advance for the production line and an accidental condition change accidentally occurring in the production line, the performance value calculation process includes calculating the production performance value by excluding, from data of the index related to productivity or quality of the product in the production line, data of the index corresponding to a statistical outlier in a distribution of the production performance value and affected by the planned condition change in the production line, and the capability value calculation process includes calculating the production capability value by further excluding, from data of the index related to productivity or quality of the product used for calculation of the production performance value, data of the index corresponding to a statistical outlier in a distribution of the production performance value and affected by the accidental condition change in the production line.

Furthermore, the present disclosure may be the production management method described above, in which the index related to productivity or quality of the product in the production line includes at least one of a production amount of the product per predetermined time, a manufacturing takt time of the product, and an error rate of the product.

Furthermore, the present disclosure may be the production management method described above, further including a result report process of creating a result report capable of comparing the production performance value and the production capability value. Furthermore, the present disclosure may be the production management method described above, further including a result report process of creating a result report capable of comparing the production performance value and the production capability value, in which the result report process includes reporting contents of the accidental condition change related to the data of the index excluded when the production capability value is calculated in the capability value calculation process. As a result, it is possible to clarify a countermeasure location for bringing the performance value close to the capability value.

Furthermore, the present disclosure may be a program for causing a computer to execute: for a production line including a single or a plurality of manufacturing devices and a single or a plurality of inspection devices, in which a manufacturing process and an inspection process of a product by the manufacturing devices and the inspection devices are executed, a performance value calculation step of calculating a production performance value that is a performance value of an index related to productivity or quality of the product in the production line; and a capability value calculation step of calculating, based on the performance value, a production capability value that is a capability value of an index related to productivity or quality of the product in the production line, in which the production capability value is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

Furthermore, the present disclosure may be the program described above, in which the predetermined condition change includes a planned condition change planned in advance for the production line and an accidental condition change accidentally occurring in the production line, the performance value calculation step includes calculating the production performance value by excluding, from data of the index related to productivity or quality of the product in the production line, data of the index corresponding to a statistical outlier in a distribution of the production performance value and affected by the planned condition change in the production line, and the capability value calculation step includes calculating the production capability value by further excluding, from data of the index related to productivity or quality of the product used for calculation of the production performance value, data of the index corresponding to a statistical outlier in a distribution of the production performance value and affected by the accidental condition change in the production line.

Note that each of the above-described configurations and processes can be combined with each other to constitute the present invention as long as no technical contradiction occurs.

### Effect of the Invention

According to the present invention, a preferential improvement point of a production line can be more clearly recognized.

### BRIEF DESCRIPTION OF THE DRAWINGS

FIG. 1 is a schematic configuration diagram of a production management system according to an example of the present invention.

FIG. 2 is a diagram for explaining a difference between a best value of a production amount in a production line and a performance value according to an example of the present invention.

FIG. 3 is a functional block diagram of a production management device according to an example of the present invention.

FIG. 4 is a flowchart of processing in the production management system according to the example of the present invention.

FIG. 5 is a diagram illustrating an example of a method of calculating a best value according to Example 1 of the present invention.

FIGS. 6A and 6B are diagrams for explaining a second example of the method of calculating a best value according to Example 1 of the present invention.

FIGS. 7A and 7B are diagrams illustrating an example of a graph described in a report according to Example 1 of the present invention.

FIG. 8 is a diagram illustrating an example of a message described in the report according to Example 1 of the present invention.

FIG. 9 is a diagram illustrating a second example of a graph described in the report according to Example 1 of the present invention.

FIG. 10 is a diagram illustrating an example of contents in a case where the report according to Example 1 of the present invention is provided by mail.

FIG. 11 is a diagram illustrating an example of contents in a case where the report according to Example 1 of the present invention is downloaded by a WEB browser.

FIG. 12 is a diagram illustrating an example of contents in a case where the report according to Example 1 of the present invention is provided by a WEB browser.

FIG. 13 is a best value calculation flowchart according to Example 2 of the present invention.

FIG. 14 is a performance value and best value calculation flowchart according to Example 3 of the present invention.

FIG. 15 is a diagram illustrating an example of data related to manufacturing of a board according to Example 5 of the present invention.

FIG. 16 is a diagram illustrating another example of data related to manufacturing of a board according to Example 5 of the present invention.

FIGS. 17A and 17B are diagrams illustrating an example of presentation of an object to be improved according to Example 5 of the present invention.

FIGS. 18A and 18B are diagrams illustrating another example of presentation of an object to be improved according to Example 5 of the present invention.

### MODE FOR CARRYING OUT THE INVENTION

### Application Example

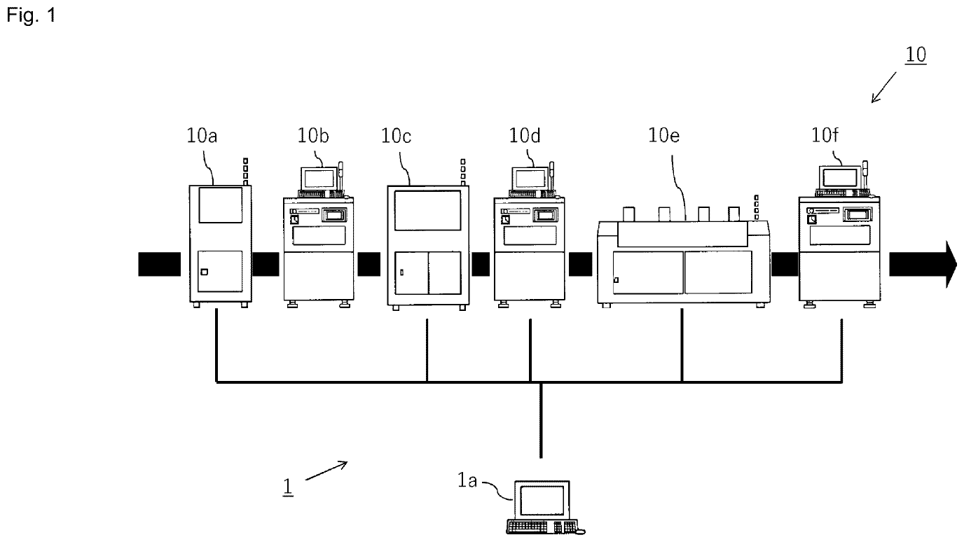

As illustrated in FIG. 1, a production line 10 to which the present invention is applied includes a solder printing device 10a, a post-solder printing inspection device 10b, a mounter 10c, a post-mount inspection device 10d, a reflow furnace 10e, and a post-reflow inspection device 10f. Each device in the production line 10 is connected to a production management device 1a via a network such as a LAN. The production management device 1a is configured by a general-purpose computer system.

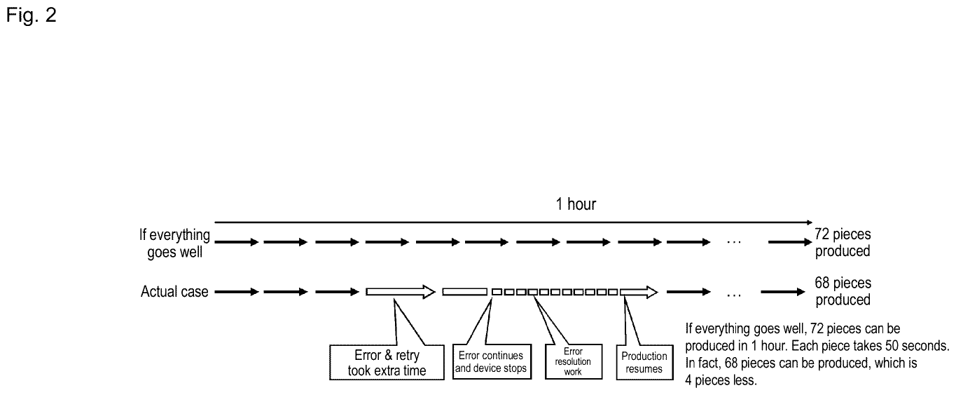

FIG. 2 illustrates a best value and a performance value of a production amount in the production line 10. Arrows shown in an upper part indicate a case where production is smoothly performed, and arrows shown in a lower part indicate an actual case. This best value corresponds to the production capability value in the present disclosure. On the other hand, the actual case in the lower part includes a 4M fluctuation scheduled in advance such as a waiting time in each manufacturing device or each inspection device, an accidental 4M fluctuation due to an unexpected cause such as a device trouble, and a fluctuation in a condition of a process for which the cause cannot be specified. The production amount in this case is a performance value. The performance value corresponds to the production performance value in the present disclosure.

In order to improve the production efficiency in the production line 10, it is necessary to finally solve all the above factors, but first, it is a priority problem to cause the production line 10 to exhibit a capability value. As described above, the present application example has a function of clarifying an actual state of the decrease in the production amount to be preferentially eliminated and reporting the actual state.

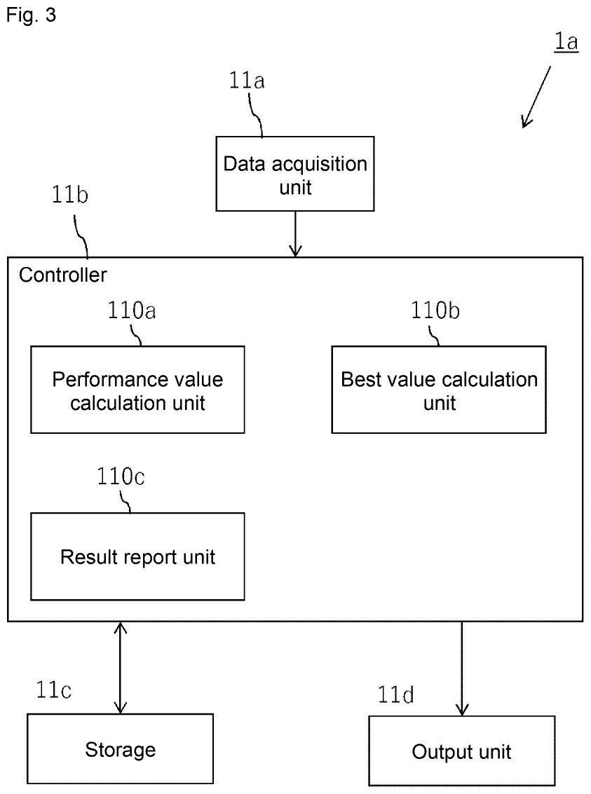

FIG. 3 illustrates a block diagram of the production management device 1a according to the present application example. The production management device 1a includes a data acquisition unit 11a that receives data from each device of the production line 10, and a controller 11b that calculates and reports a best value and a performance value of the production line 10. Furthermore, the production management device 1a includes a storage 11c that stores the data acquired by the data acquisition unit 11a, the best value and the performance value calculated by the controller 11b, and contents of a report, and an output unit 11d that can output various data and the contents of the report. The controller 11b further includes functional units of a performance value calculation unit 110a, a best value calculation unit 110b, and a result report unit 110c as functional modules. The best value calculation unit 110b corresponds to the capability value calculation unit in the present disclosure.

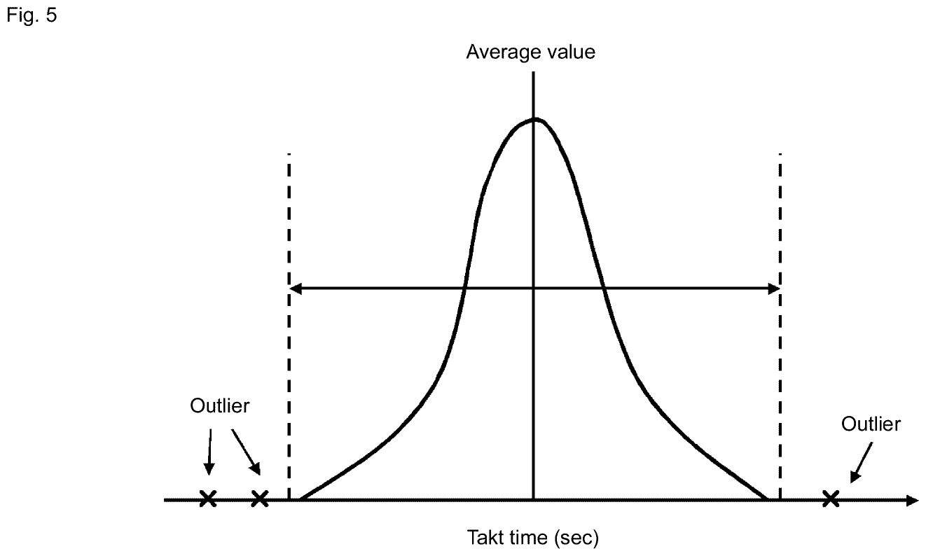

In a case where the best value calculation unit 110b calculates the best value from the performance value of the production amount, for example, as illustrated in FIG. 5, a frequency distribution of a takt time as a performance value calculated by the performance value calculation unit 110a is subjected to the Smirnov-Grubbs test to exclude outliers. Then, the test is performed on all the data until there is no outlier, and the frequency distribution when there is no outlier is taken as the frequency distribution of the best value.

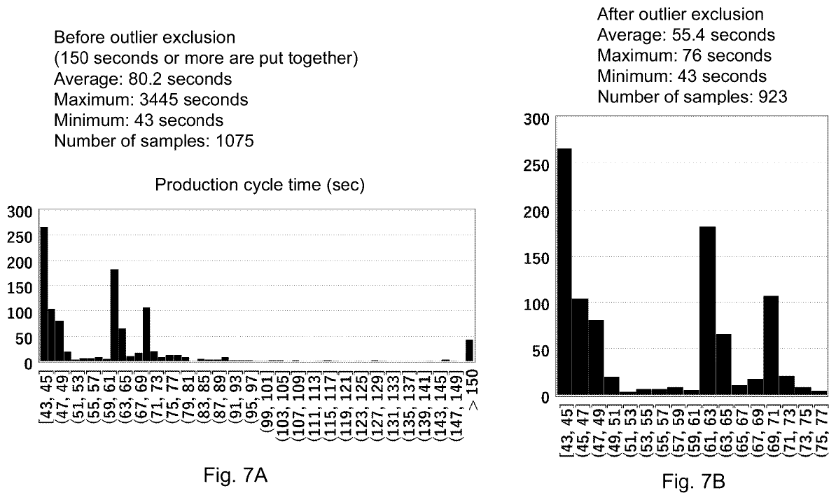

The production management device 1a outputs a report including a production amount calculated for the production line 10, and a capability value and a performance value of the takt time. FIGS. 7A and 7B illustrate an example of graphs posted at the time of creating a description example of a report. In the report, as illustrated in FIG. 7A, a histogram before an outlier of the production cycle time (takt time) is excluded may be described as a performance value. Furthermore, a histogram after outlier exclusion as illustrated in FIG. 7B may be described as a capability value.

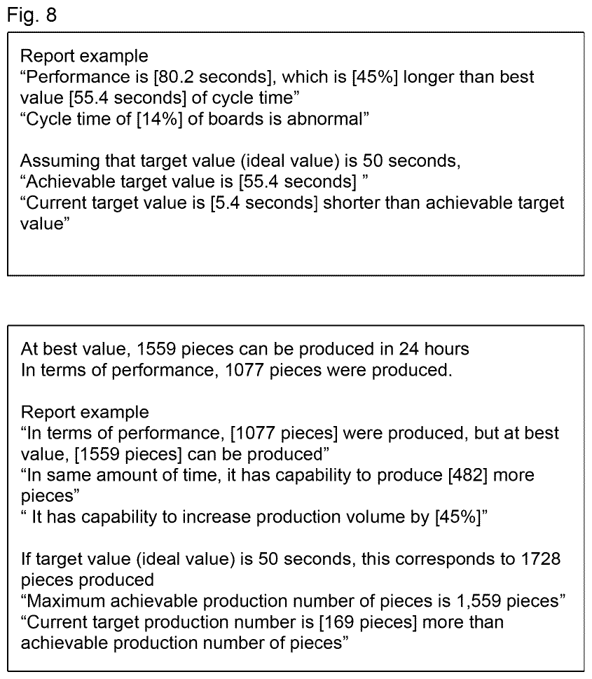

The report may further include a message as illustrated in FIG. 8. In an upper part, numerical values of the best value and the performance value of the cycle time (takt time), a ratio of the two numerical values, and a ratio of outliers are described. Furthermore, a difference between the best value and an ideal value is also described. Furthermore, as illustrated in a lower part of FIG. 8, the number of products may be described. More specifically, the best value and the performance value of the production number are displayed, and a difference between the best value and the performance value and a difference between the ideal value and the best value may also be described.

Hereinafter, embodiments of the present invention will be described with reference to the drawings. However, the constituent elements described in each example below are not intended to limit the scope of the present invention only to the constituent elements unless otherwise specified.

### Example 1

The production management system 1 according to the present invention includes, for example, the production line 10 as illustrated in FIG. 1, and performs production management of the production line 10. The production line 10 in FIG. 1 is a surface mounting line of a printed circuit board. As illustrated in FIG. 1, the production line 10 according to the example is provided with the solder printing device 10a, the post-solder printing inspection device 10b, the mounter 10c, the post-mount inspection device 10d, the reflow furnace 10e, and the post-reflow inspection device 10f in this order from an upstream side.

The solder printing device 10a is a device that prints an electrode-portion solder paste on a printed circuit board. The mounter 10c is a device for placing on a solder paste a large number of electronic components to be mounted on a printed board. Furthermore, the reflow furnace 10e is a heating device for solder-bonding an electronic component placed on the printed circuit board to printed wiring on the printed circuit board. Each of the post-solder printing inspection device 10b, the post-mount inspection device 10d, and the post-reflow inspection device 10f inspects a state of the printed circuit board at the exit of each process, and automatically detects a defect or the possibility of the defect.

The solder printing device 10a, the mounter 10c, the reflow furnace 10e described above (Hereinafter, these are also collectively referred to as manufacturing devices.), and the post-solder printing inspection device 10b, the post-mount inspection device 10d, and the post-reflow inspection device 10f (Hereinafter, these are also collectively referred to as inspection devices.) are connected to the production management device 1a via a network such as a LAN. The production management device 1a is configured by a general-purpose computer system including a CPU (processor), a main storage device (memory), an auxiliary storage device (hard disk or the like), an input device (keyboard, mouse, controller, touch panel, etc.), an output device (display, printer, speaker, etc.), and the like.

Here, a difference between the best value of the production amount in the production line 10 and the performance value will be described with reference to FIG. 2. FIG. 2 illustrates the production amount of the printed circuit board in two cases. The horizontal axis of the drawing represents time, for example, a time range of one hour. Furthermore, each arrow represents a time when one board is manufactured. The arrows described in the upper part indicate a case where production is smoothly performed, and the arrows described in the lower part indicate an actual case where various troubles (including those whose cause is known and those whose cause is unknown) or delays due to the influence of a so-called 4M fluctuation occur.

The production amount described in the upper part in a case where production is smooth can also be referred to as a capability value of a target production line, and this production amount is referred to as a best value in the embodiment. In this case, as illustrated in FIG. 2, for example, in a case where an average takt time T is 50 seconds, 3600 seconds/T=72 pieces can be produced for 1 hour.

On the other hand, in the case of the lower part of FIG. 2, an error & retry due to component suction failure occurs in the mounter 10c in the middle of 1 hour, and it takes an extra time. Thereafter, the device stops due to continuous occurrence of errors caused by the component suction failure, work for resolving the errors is performed, and production is resumed after the work is completed. In such a case, although 72 pieces can be originally produced in 1 hour, only 68 pieces can be produced, and the production amount per hour is 4 pieces less than the best value. The production amount in this case is a performance value. As described above, the performance value also includes a delay caused by the influence of a so-called 4M fluctuation.

In order to improve the production efficiency in the production line 10, it is necessary to eventually eliminate both an accidental factor such as the above-described trouble and a planned factor such as the influence of the 4M fluctuation. In the example, as described above, a function of clarifying factors such as various troubles and an actual state of the decrease in the production amount due to the influence of the 4M fluctuation and reporting the actual state is provided.

FIG. 3 is a schematic block diagram of the production management device 1a according to the example. As illustrated in FIG. 3, the production management device 1a includes the data acquisition unit 11a that receives data from each manufacturing device and each inspection device of the production line 10, and the controller 11b that calculates and reports the best value and the performance value of the production line 10 based on the data acquired by the data acquisition unit 11a. Furthermore, the storage 11c that stores the data acquired by the data acquisition unit 11a, the best value and the performance value calculated by the controller 11b, and the contents of the report, and the output unit 11d that can output various data and the contents of the report are included. The controller 11b further includes the performance value calculation unit 110a, the best value calculation unit 110b, and the result report unit 110c as functional modules. Each functional module is realized, for example, by a CPU (not illustrated) reading and executing a program stored in the storage 11c.

In addition, information related to an inspection condition from a user, a performance value calculation command to the performance value calculation unit 110a, a best value calculation command to the best value calculation unit 110b, a report creation command to the result report unit 110c, and the like are input to the data acquisition unit 11a.

The performance value calculation unit 110a calculates an actual value of the production amount of the production line 10 in a designated period based on the data from each manufacturing device and each inspection device acquired by the data acquisition unit 11a. The best value calculation unit 110b calculates the best value of the production amount of the production line 10 based on the performance value calculated by the performance value calculation unit 110a. The result report unit 110c creates a report on the basis of the performance value of the production amount of the production line 10 calculated by the performance value calculation unit 110a and the best value of the production amount of the production line 10 calculated by the best value calculation unit 110b.

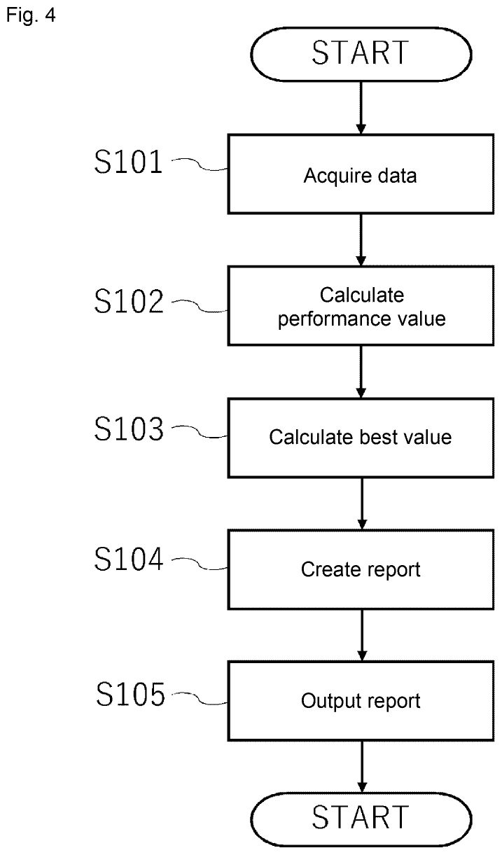

FIG. 4 illustrates a flowchart of processing in the production management device 1a. When this flow is executed, first, in step S101, data of manufacturing performance and an inspection result is acquired from each manufacturing device and each inspection device of the production line 10. The manufacturing performance data includes log data such as a time and contents of an error that has occurred and a countermeasure that has been taken. The data of the inspection result includes log data such as the number of occurrences and occurrence time for each defect item. The acquired data is stored in the storage 11c. When the processing of step S101 ends, the process proceeds to step S102. In step S102, the performance value calculation unit 110a calculates the performance value of the production number and stores the performance value in the storage 11c. In the example, as illustrated in FIG. 2, the production number per hour is calculated as the performance value. The performance value may be stored for each hour as the production number for each hour, or may be stored as, for example, an average value of the operating time of the production line 10. When the processing of step S102 ends, the process proceeds to step S103.

In step S103, the best value of the production number is calculated by the best value calculation unit 110b and stored in the storage 11c. In calculating the best value, as an example, a general method such as the Smirnov-Grubbs test may be used. Hereinafter, a specific example of a method of calculating the best value will be described.

### Calculation Example 1 of Best Value

When the best value is calculated, for example, as illustrated in FIG. 5, the normal distribution is assumed for a histogram of the takt times of the respective products (boards) related to the performance value of the production number calculated in step S102, and value of test target-average value/standard deviation σ is tested with the superiority level as 5%. Then, only one piece of data that is the most deviated is tested, and when it is determined as an outlier, a sample that is the second deviated is tested using n-1 samples excluding the outlier, and the test is repeated until no outlier is detected. An average value of the remaining takt times is the best value of the takt times, and a value obtained by dividing one hour by the best value of the takt times is the best value of the production number per hour.

### Calculation Example 2 of Best Value

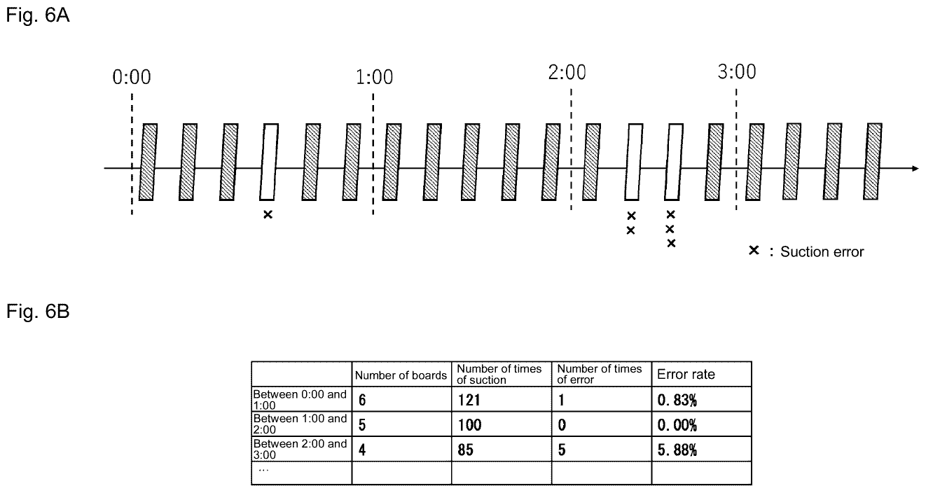

FIGS. 6A and 6B illustrate a second calculation example of the best value in the embodiment. In this example, for example, the best value of a suction error rate when a component is sucked by a suction nozzle (not illustrated) in the mounter 10c is calculated. Ideal value in this case=error rate 0%. The performance value is, for example, suction error rate (%)=(number of errors/number of times of suction) per hour. Then, error rate counting is performed every hour, and the error rate at each time is subjected to a test as data related to the test. Then, the average value of the suction error rate (%) that remains finally is set as the best value.

FIG. 6A is a graphical representation of the method of calculating the suction error rate in this example. In FIG. 6A, the horizontal axis represents time. A length in a lateral direction of quadrilaterals aligned in time series represents the time during which a component mounting process is performed on one board. Among them, hatched quadrilaterals represent boards with zero suction error during work. The outlined quadrilaterals represent boards with a suction error during work. Furthermore, the number of x's described below the outlined quadrilateral corresponds to the number of suction errors. Note that, in this drawing, for example, 20 components are mounted per board, and retry is performed when a suction error occurs once. Therefore, it is assumed that the number of times of suction increases accordingly.

FIG. 6B is a table showing the number of production boards (production number), the total number of times of suction, the number of times of error, and the error rate during each time. As illustrated in FIG. 6B, in this drawing, the mounting process was performed on six boards between 0:00 and 1:00, and a suction error occurred once in one of the six boards. The error rate during this time is 0.83%. Between 1:00 and 2:00, the mounting process was performed on five boards, and no suction error occurred. The error rate during this time is 0.00%. Between 2:00 and 3:00, the mounting process was performed on four boards, and the suction error occurred twice in one board and three times in another board, that is, a total of five times. The error rate during this time is 5.88%. The error rate thus obtained is tested, and the average value of the error rates that have not been excluded as outliers is the best value of the error rate. Returning to the description of FIG. 4, when the processing of step S103 ends, the process proceeds to step S104.

In step S104, a report is created in such a manner that the performance value and the best value can be compared. Hereinafter, the report created in step S104 will be described.

### Creation Example of Report

FIGS. 7A and 7B illustrates an example of a graph posted at the time of creating a report. In the report, as illustrated in FIG. 7A and the like, for example, a histogram before the outlier is excluded in which the production cycle time (takt time) is described on the horizontal axis and the frequency is described on the vertical axis. Furthermore, an analysis result of the data is displayed together with the histogram. In this example, it can be seen that an average value of the takt times is 80.2 seconds, the maximum value is 3445 seconds, the minimum value is 43 seconds, the number of samples is 1075, and the performance value of the takt time is 80.2 seconds. Furthermore, the report also includes a histogram after outlier exclusion as illustrated in FIG. 6B. From this graph, it can be seen that an average value after the outlier exclusion of the tact times is 55.4 seconds, the maximum value is 76 seconds, the minimum value is 43 seconds, and the number of samples is 923, and the best value of the tact time is 55.4 seconds.

FIG. 8 illustrates an example of a message described in the report. A description of the production cycle time (takt time) is shown in the upper part. Numerical values of the best value and the performance value of the production cycle time (takt time), a ratio of the two numerical values, and a ratio of outliers are described. Furthermore, a difference between the best value and an ideal value is also described. Here, the ideal value is a target value of the production cycle time (takt time) determined in advance for another reason such as a business plan, regardless of the capability value of the production line 10. This ideal value corresponds to the production target value in the present disclosure. In the lower part, the number of manufacturing is described. Here, the best value and the performance value of the production number of pieces are also displayed, and a difference between the best value and the performance value is described as a difference between the capability and the actual. A difference between the ideal value and the best value of the production number of pieces is also described.

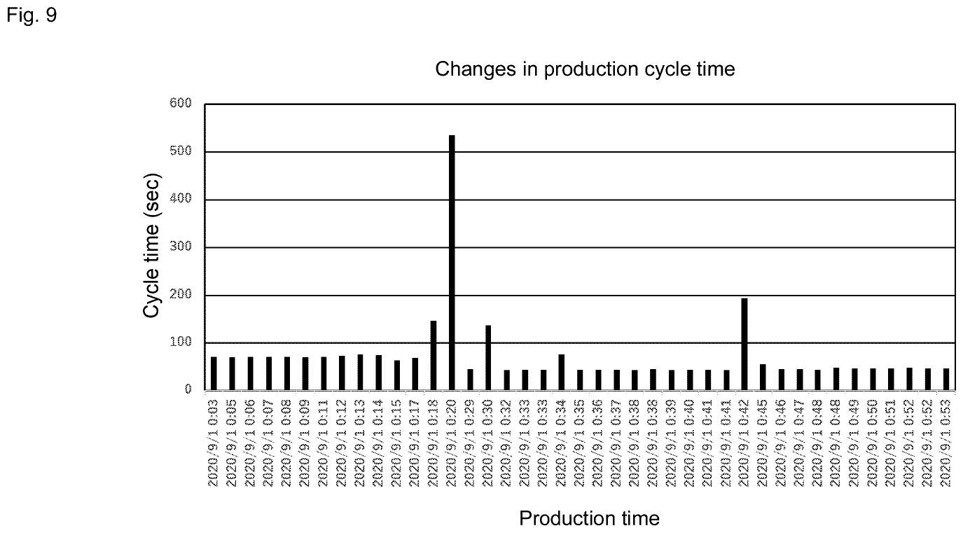

FIG. 9 illustrates a bar graph plotting production time on the horizontal axis and cycle time on the vertical axis, rather than a histogram. Such a graph may be described in the report. Furthermore, in this case, the plot corresponding to the outliers may be outlined by changing the color.

The description returns to FIG. 4. When the processing of step

S104 ends, the process proceeds to step S105. In step S105, the report created in step S104 is output and provided to a predetermined report destination. Hereinafter, a method of report output (provision) will be described.

<Method of outputting report>

As a method of outputting the report, the following is considered.

### (1) Email

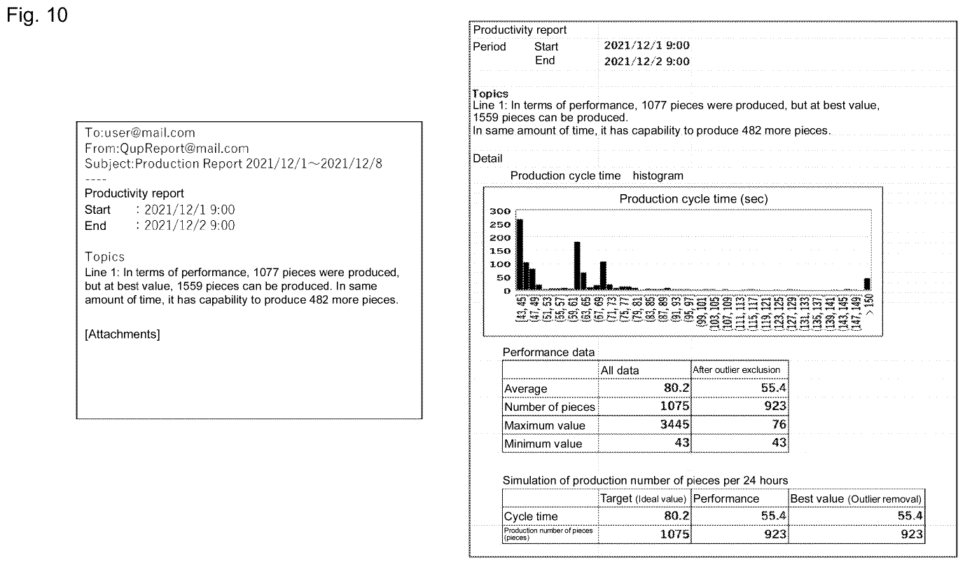

In this case, the summary of an aggregation period/aggregation target and topics may be described in the mail text, and a report file may be attached to the mail (Excel file or the like). FIG. 10 illustrates an example of report contents in a mail and a report file to be attached.

### (2) Download by WEB Browser

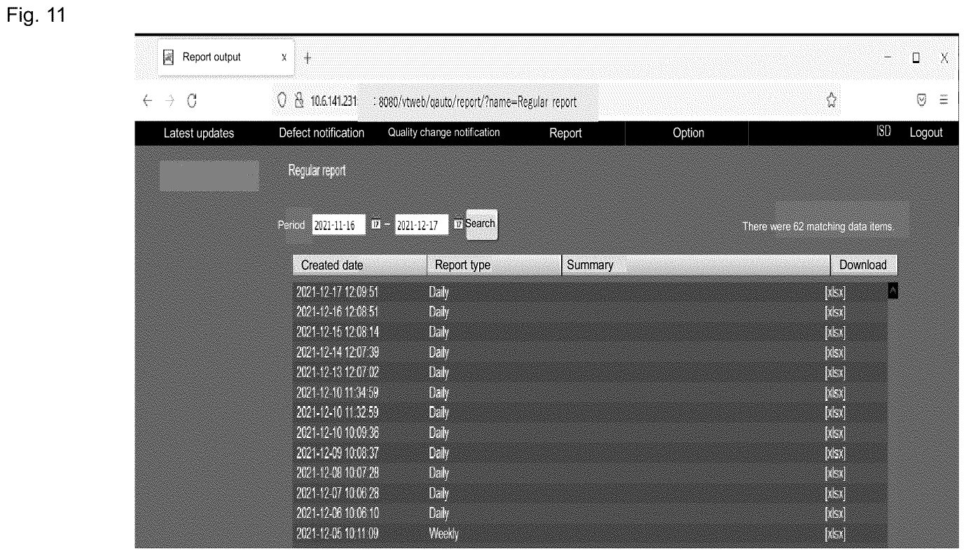

In this case, a report for each creation date can be downloaded at a specific URL. As a result, the report can be acquired by accessing the URL at any time by a user of the report provision destination. FIG. 11 illustrates an example of a download screen. In this example, a report by the Excel file can be downloaded for every operating day.

### (3) Provision by WEB Browser

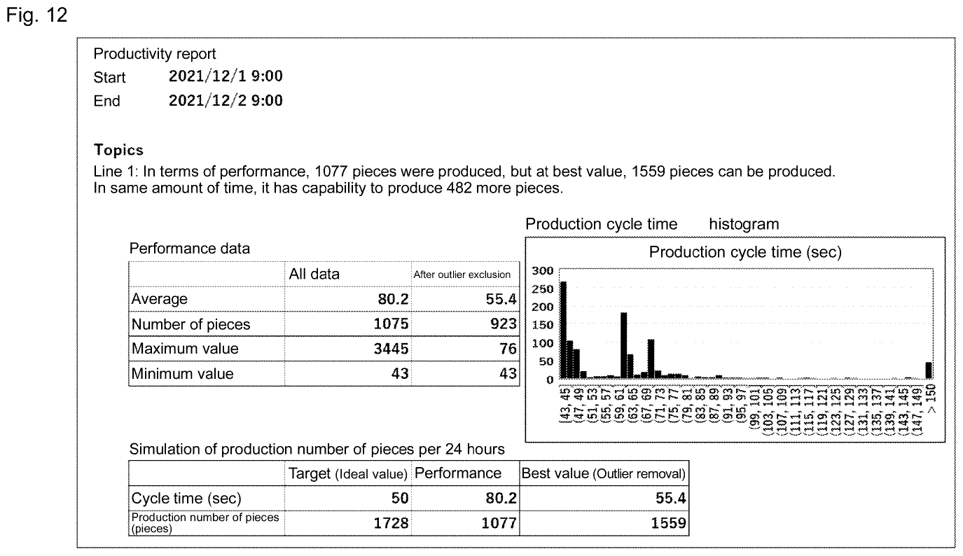

Furthermore, the report may be browsable on a specific WEB page using a WEB browser. Furthermore, the report may be provided by being embedded in a linkable manner so as to be linkable to a specific WEB page. FIG. 12 illustrates a screen of the WEB browser.

Note that, in the above report, an example has been described in which the takt time, the ideal value, and the best value and the performance value of the production number, and the difference therebetween are described, but values converted into amounts of sales, profits, and the like may be described in addition thereto.

The description returns to FIG. 4. When the processing of step

S105 ends, this routine is temporarily ended.

### Example 2

In Example 1 described above, an example has been described in which the best value, which is the capability value in the production line, is calculated by excluding data corresponding to a statistical outlier from the data related to the performance value in the production line. In the example, an example in which data affected by a 4M fluctuation is excluded instead of excluding the statistical outlier will be described.

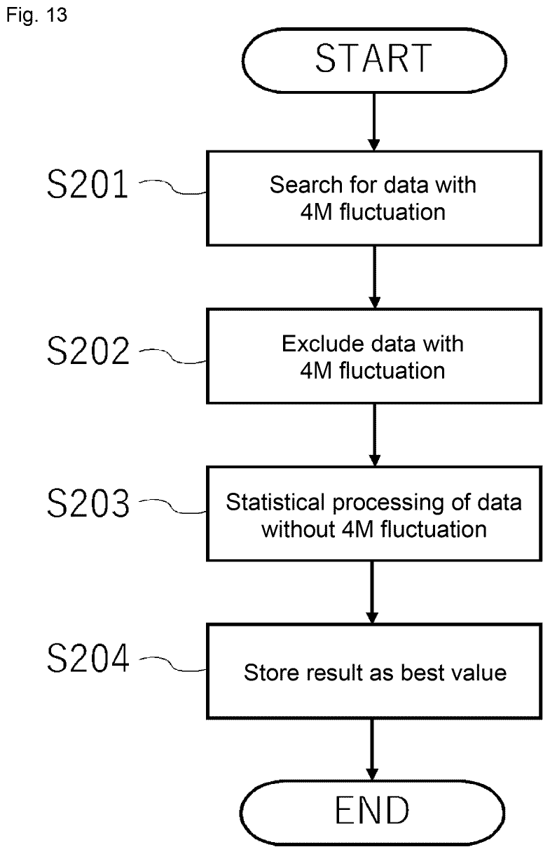

FIG. 13 illustrates a best value calculation flowchart related to the calculation of the best value in the example. This flowchart is a flowchart describing the processing corresponding to step S103 in FIG. 4 in more detail. When this flow is executed, first, in step S201, data affected by the 4M fluctuation is searched in the production of a target product. That is, the data on products affected by the 4M fluctuation is searched from a timing when the 4M fluctuation is performed. Note that, in the example, it is not distinguished whether the 4M fluctuation is planned in advance or accidental.

Next, in step S202, for example, the data having the influence of the 4M fluctuation searched in S201 is excluded from the data for calculating the production number or the takt time during a predetermined time. Then, in step S203, an average value of the production number and the takt time is calculated using only the data without the influence of the 4M fluctuation obtained in step S202. Note that, for example, for the production number during the predetermined time, the number of pieces of products affected by the 4M fluctuation is subtracted, and the manufacturing time of the products affected by the 4M fluctuation is also subtracted from the predetermined time. Then, for example, the production number per hour may be calculated by proportional calculation.

In step S204, a result calculated in step S203 is stored in the storage 11c as the best value. When the processing of step S204 ends, this flow is temporarily ended. Note that, in this case, at the time of outputting the report corresponding to step S105 in FIG. 4, all of the 4M fluctuations regarding the data excluded in step S202 may be listed.

According to the method for calculating the best value as described above, it is possible to exclude the influence of the 4M fluctuation from the performance value, improve the accuracy of the best value, and clarify which 4M fluctuation affects the ability of the process.

### Example 3

In Example 2 described above, an example has been described in which the best value that is the capability value in the production line is calculated by excluding the data affected by the 4M fluctuation from the data related to the performance value in the production line. In the example, an example will be described in which, when the performance value in the production line is calculated, data that is a statistical outlier and is affected by a planned 4M fluctuation scheduled in advance is excluded, and when the best value in the production line is calculated next, data that is a statistical outlier and is affected by an accidental 4M fluctuation is excluded.

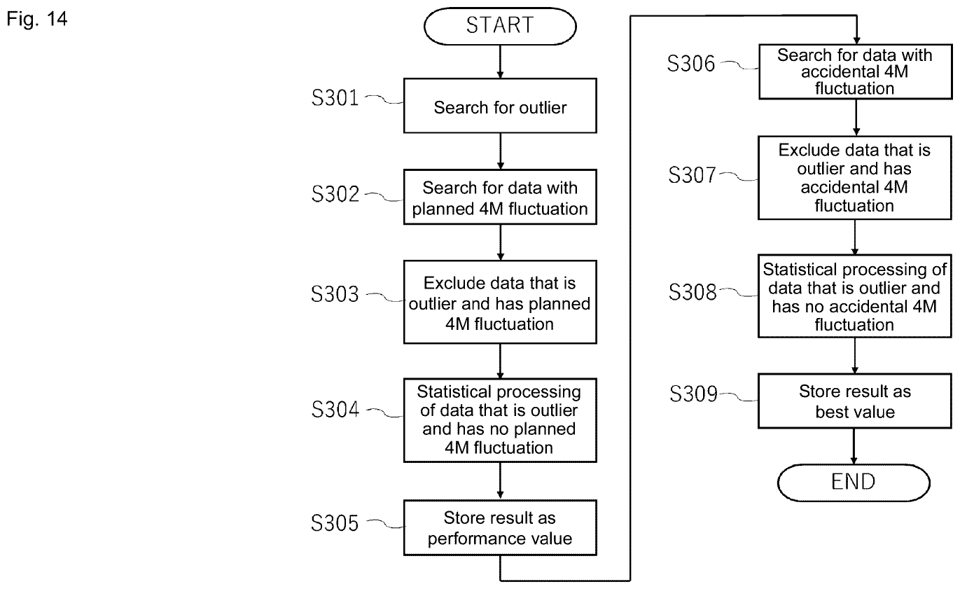

FIG. 14 illustrates a flowchart of performance value and best value calculation related to the calculation of the performance value and the best value in the example. This flowchart is a flowchart for explaining in more detail the processing corresponding to steps S102 and S103 in FIG. 4. When this flow is executed, first, in step S301, data corresponding to an outlier is searched among data of an index related to the productivity or the quality of the target product. Next, in step S302, data affected by a planned 4M fluctuation scheduled in advance is searched among the data. Note that this planned 4M fluctuation corresponds to a planned condition change in the example.

Then, in step S303, among the data of the index related to the productivity or the quality of the target product, the data corresponding to the outlier and affected by the planned 4M fluctuation scheduled in advance is excluded from, for example, the data for calculating the production number or the takt time during the predetermined time. Then, in step S304, an average value of the production number and the takt time is calculated using the data obtained in step S303 from which the data that is the outlier and affected by the planned 4M fluctuation is excluded. Then, in step S305, the calculated value is stored in the storage 11c as the performance value.

Next, in step S306, among the data used for calculating the performance value, data affected by an accidental 4M fluctuation that has accidentally occurred in the manufacturing and inspection processes of the product is further searched. Note that this accidental 4M fluctuation corresponds to an accidental condition change in the example.

Then, in step S307, data corresponding to the outlier and affected by the accidental 4M fluctuation is further excluded from the data used for calculating the performance value. Then, in step S308, an average value of the production number and the takt time is calculated using the data obtained in step S307 from which the data that is the outlier and affected by the accidental 4M fluctuation is excluded. Then, in step S309, the calculated value is stored in the storage 11c as the best value. When the processing of step S309 ends, this flow is temporarily ended. Note that, in this case, at the time of outputting the report corresponding to step S105 in FIG. 4, all of the accidental 4M fluctuations regarding the data excluded in step S308 may be listed.

According to the calculation method of the performance value and the best value as described above, the influence of the planned 4M fluctuation and the accidental 4M fluctuation can be excluded from the performance value, the accuracy of the best value can be improved, and in particular, it is possible to clarify which accidental 4M fluctuation affects the best value of the process.

Here, as will be described in detail later, the planned 4M fluctuation includes product model switching, planned maintenance, condition change, and the like. Furthermore, in the case of manufacturing a board, the accidental 4M fluctuation includes reel replacement of a mounter, emergency stop due to frequent mounting errors, adjustment by determination of a worker, condition change by determination of a worker, and the like.

### Example 4

Next, as Example 4, a specific example of association between 4M fluctuation information and evaluation data will be described.

### (Association Between 4M Fluctuation Information and Evaluation Data)

Specifically, the 4M fluctuation information and data of each product may be associated as follows.

(1) In the case of a 4M fluctuation occurring during mounting and inspection of a predetermined board (between carrying-in and carrying-out of the board)

The production cycle time (a difference between the carry-out time of the predetermined board and the carry-out time of the next board) is associated with the next board. In this case, the influence of the 4M fluctuation is reflected in the production cycle time of the next board. Furthermore, the error rate is associated with the corresponding board. In this case, the influence of the 4M fluctuation is reflected in samples (the number of components mounted and inspected and the number of error components) of the corresponding board.

(2) In the case of a 4M fluctuation occurring in other than those described above (other than during mounting and inspection)

The production cycle time (a difference between the carry-out time of the predetermined board and the carry-out time of the next board) is associated with the next board. In this case, the influence of the 4M fluctuation is reflected in the production cycle time of the next board. Furthermore, for the error rate, samples of the corresponding board (the number of components mounted and inspected and the number of error components) are excluded. In this case, the influence of the 4M fluctuation is reflected in the samples (the number of components mounted and inspected and the number of error components) of the board.

As described above, the 4M fluctuation occurring from the carrying-out of the predetermined board to the carrying-out of the next board is associated with the next board.

(Classification and acquisition method of 4M fluctuation information) Next, an example of classification of 4M fluctuation information and an acquisition method for each type of 4M fluctuation will be described.

### (1) Planned 4M Fluctuation

### (1-1) Product Model Switching (Set-Up Switching)

A program name is acquired from the mounting and inspection data (premise to process from old for each device), and when the program name is changed from a preceding board, the program name is associated with the corresponding board. Furthermore, for information indicating that a program of a mounting machine and an inspection machine has been replaced (program name and time after replacement), the information is output from the device to the production management device 1a, and is associated with a board of the device immediately after the time.

### (1-2) Work on Planned Device (Maintenance, Condition Change, Etc.)

A work plan for a device is registered in advance, and the fact that some change has been made to the planning device is output from the device to the production management device 1a. When the work plan for the device is in the vicinity (within 30 minutes before and after, etc.), the work plan is associated with a board of the device immediately after the time. Furthermore, the worker registers the fact that the planned work has been performed in the production management device 1a with a terminal, and associates the information with a board of the device immediately after the time.

### (2) Accidental 4M Fluctuation

### (2-1) Reel Replacement of Mounter

The reel ID attached to a feeder is acquired from mounting data (premise to process from old for each device), and when the reel ID is changed from a preceding board or a middle of the current board, the reel ID is associated with the corresponding board. Furthermore, information indicating that the feeder has been detached by the mounting machine is output from the device to the production management device 1a together with the reel ID, and when the reel ID has been changed, the information is associated with a board of the device immediately after the time.

### (2-2) Emergency Stop Due to Frequent Mounting Errors

Information indicating that the mounting machine is stopped is output from the device to the production management device 1a, and is associated with a board of the device immediately after the time.

### (2-3) Work on Unplanned Device (Adjustment Based on Judgment of a Worker, Condition Change, Etc.)

A work plan for a device is registered in advance, and the fact that some change has been made to the planning device is output from the device to the production management device 1a. When the work plan for the device is not in the vicinity (within 30 minutes before and after, etc.), the work plan is associated with a board of the device immediately after the time. Furthermore, the worker registers the fact that unplanned work has been performed in the production management device 1a with a terminal, and associates the information with a board of the device immediately after the time. Note that the board immediately after may not be specified within how many minutes, but may be the oldest board after that time.

### Example 5

Hereinafter, as a more specific example, an aspect of handling data for each board in a case where the production cycle time is used as an index related to the productivity or quality of a product and (the performance value and) the base value is calculated will be described.

### [First Aspect]

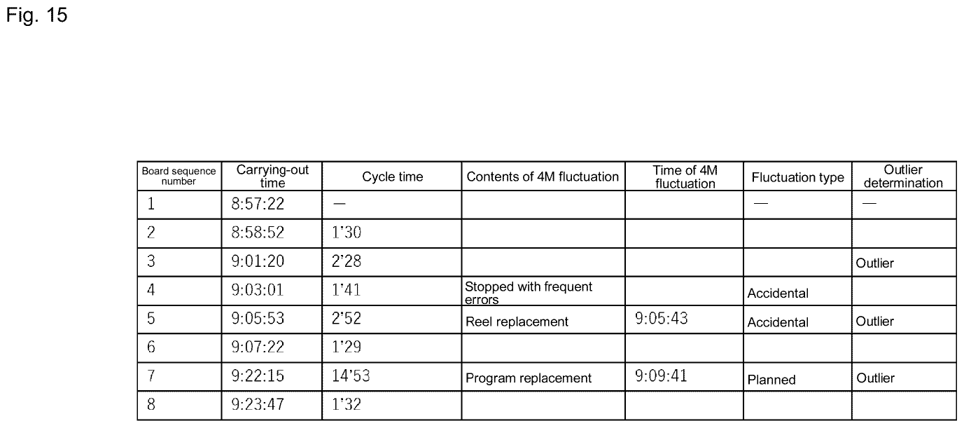

FIG. 15 illustrates data of board sequence numbers 1 to 8. In this case, in a case where the best value is calculated, the data of the board sequence number 1 is excluded from the statistical sample because there is no previous board. The data of the board sequence number 3 is an outlier but is not excluded from the sample because there is no 4M fluctuation. The data of the board sequence number 5 is an accidental fluctuation and an outlier, but is not excluded from the sample. The data of the board sequence number 7 is excluded from the sample because it is a planned fluctuation and an outlier. Then, the performance value is calculated from the remaining board data.

Then, in addition to the above, in a case where the best value is calculated, the data of the board sequence number 3 is an outlier but there is no 4M fluctuation, and thus it is not excluded (this may be excluded and the best value may be calculated. In this case, improvement contents are unknown and cannot be presented. The best value is defined as a target value that can be achieved if the room for improvement is eliminated although the point for improvement is unknown at present.). Furthermore, the data of the board sequence number 4 is an accidental fluctuation, but is not an outlier, and thus is not excluded from the sample. The data of the board sequence number 5 is excluded from the sample as it is an accidental fluctuation and an outlier.

Then, a capability value is calculated for the remaining boards. That is, the definition of the best value is a target value that can be achieved if the improvement point is known and eliminated.

That is, in this aspect, the performance value is calculated by excluding the samples affected by the planned 4M fluctuation and having the outlier from the process data, and the best value is calculated by further excluding the samples affected by the accidental 4M fluctuation and having the outlier. As a result, the best value is calculated by excluding the samples affected by the 4M fluctuations and having an outlier.

### [Second Aspect]

Next, a second aspect of handling data in a case where the best value is calculated using the production cycle time as an index will be described. This is an aspect of excluding outliers. Here, since there is no previous board in the board sequence number 1 in FIG. 15, it is excluded from the sample. Since the board sequence numbers 3, 5, and 7 are outliers, they are excluded from the sample. Then, a capability value is calculated for the remaining boards. In this case, the best value is defined as a target value that can be achieved if the room for improvement is eliminated although the point for improvement is unknown at the present time.

That is, in this aspect, the best value is calculated by excluding the outlier samples from the process data.

### [Third Aspect]

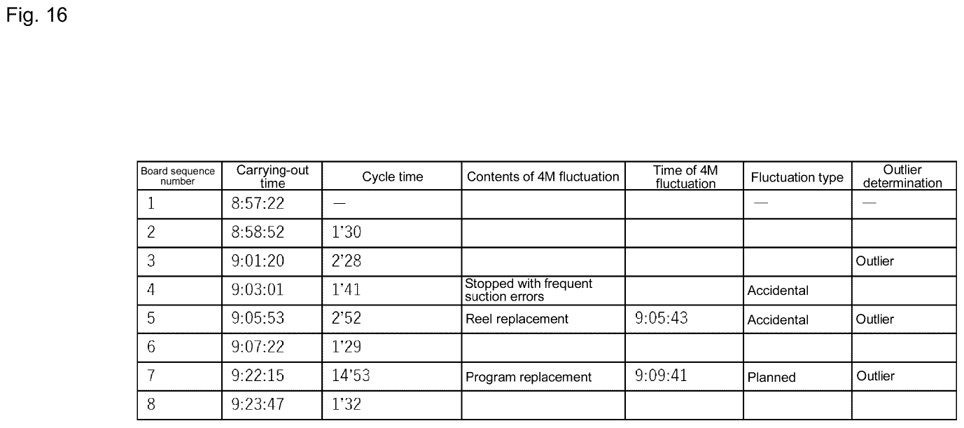

Next, a third aspect of handling data in a case where the best value is calculated using the production cycle time as an index will be described. This is an aspect in which 4M fluctuations are not distinguished by being planned or accidental. Here, the board sequence number 1 in FIG. 16 is excluded from the sample because there is no previous board. The data of the board sequence number 3 is an outlier, but is not excluded because there is no 4M fluctuation. (Although improvement contents cannot be indicated, the capability value may be calculated by excluding the data of the board sequence number 3.) The data of the board sequence number 4 has a 4M fluctuation, but is not excluded from the sample because it is not an outlier. The data of the board sequence number 5 has a 4M fluctuation and is an outlier, and thus is excluded from the sample. The data of the board sequence number 7 has a 4M fluctuation and is an outlier, and thus is excluded from the sample. Then, the best value is calculated for the remaining boards. In this aspect, planned (grasped) 4M fluctuation factors are also listed as improvement targets. [Fourth aspect]

Next, a fourth aspect of handling data in a case where the best value is calculated using the production cycle time as an index will be described. FIG. 16 illustrates data of the board sequence numbers 1 to 8. This is an aspect that does not use outliers. Here, since there is no previous board in the board sequence number 1, it is excluded from the sample. The data of the board sequence number 5 is not excluded from the sample because it is an accidental fluctuation. Since the data of the board sequence number 7 is a planned fluctuation, it is excluded from the sample. Then, a performance value is calculated for the remaining boards. Moreover, (in addition to the above,) the data of the board sequence numbers 4 and 5 are excluded from the sample because they are accidental fluctuations. Then, the best value is calculated for the remaining boards. In this case, the best value is defined as a target value that can be achieved if the known 4M fluctuation is eliminated (a target value that can be achieved in a case where what is better if there is nothing is eliminated).

### [Fifth Aspect]

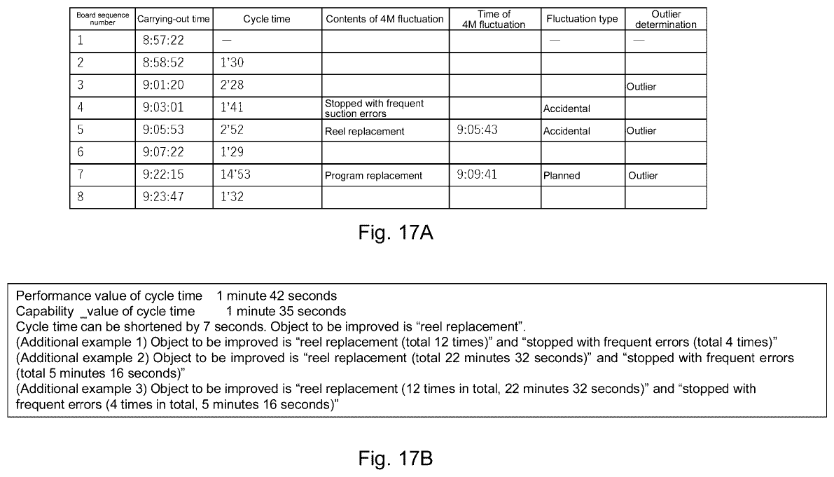

Next, presentation of an object to be improved will be described. Here, in a case where the production cycle time is used as an index and the best value is calculated, a 4M fluctuation (reel replacement) of the sample excluded when the best value is calculated in the first aspect of data handling is presented as an improvement target. FIG. 17A illustrates data of the board sequence numbers 1 to 8 again. Furthermore, an example of a sentence to be presented is illustrated in FIG. 17B. The posting text describes that the performance value of the production cycle time is 1 minute 42 seconds, the best value of the production cycle time is 1 minute 35 seconds, the production cycle time can be shortened by 7 seconds, and the object to be improved is “reel replacement”. Furthermore, the point that the object to be improved is “reel replacement (total 12 times)” and “stopped with frequent errors (total 4 times)” may be presented together with the number of times. Furthermore, the object to be improved may be presented together with the total time, such as “reel replacement (total 22 minutes 32 seconds)” and “stopped with frequent errors (total 5 minutes 16 seconds)”. Here, the total time is the sum of “values of excluded samples-best value” (increased by the 4M fluctuation). Moreover, the object to be improved may be presented together with the number of times and the total time, such as “reel replacement (12 times in total, 22 minutes 32 seconds)” and “stopped with frequent errors (4 times in total, 5 minutes 16 seconds)”.

### [Sixth Aspect]

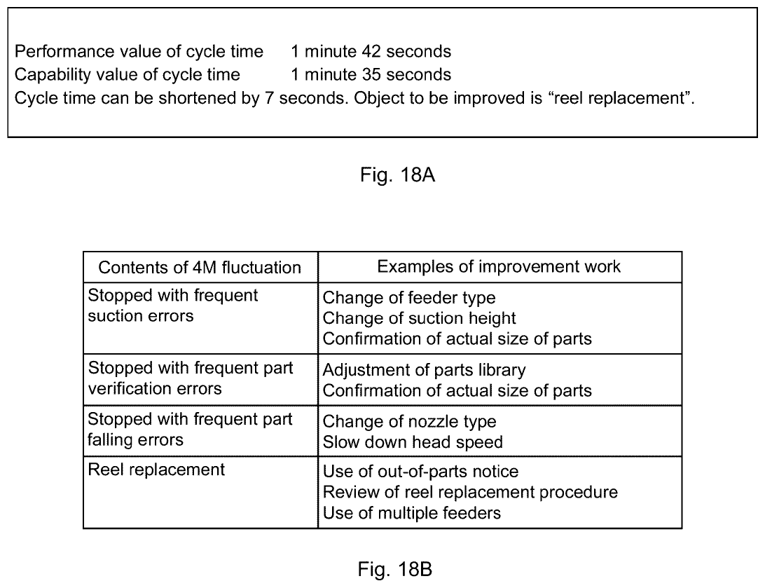

Next, another aspect regarding presentation of an object to be improved will be described. An example of a sentence to be presented is illustrated in FIG. 18A. Here, it is presented that the performance value of the production cycle time is 1 minute 42 seconds, the best value of the production cycle time is 1 minute 35 seconds, the production cycle time can be shortened by 7 seconds, and the object to be improved is “reel replacement”. Here, as for the object to be improved, as illustrated in FIG. 18B, a specific work may be registered in the system in advance and additionally presented as an example.

Note that, in order to make it possible to compare the constituent elements of the present invention with the configurations of the examples, the constituent elements of the present invention will be described below with symbols in the drawings.

### <Supplementary Note 1>

A production management system (1) related to a production line (10) including a single or a plurality of manufacturing devices and a single or a plurality of inspection devices, in which a manufacturing process and an inspection process of a product by the manufacturing devices and the inspection devices are executed, the production management system (1) including:

a performance value calculation unit (110a) configured to calculate a production performance value that is a performance value of an index related to productivity or quality of the product in the production line (10); and a capability value calculation unit (110b) configured to calculate, based on the performance value, a production capability value that is a capability value of an index related to productivity or quality of the product in the production line, in which the production capability value is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

### <Supplementary Note 6>

A production management method in a production line (10) including a single or a plurality of manufacturing devices and a single or a plurality of inspection devices, in which a manufacturing process and an inspection process of a product by the manufacturing devices and the inspection devices are executed, the production management method including:

a performance value calculation process (S102) of calculating a production performance value that is a performance value of an index related to productivity or quality of the product in the production line (10); and

a capability value calculation process (S103) of calculating, based on the performance value, a production capability value that is a capability value of an index related to productivity or quality of the product in the production line,

in which the production capability value is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

<Supplementary note 11>

A program for causing a computer (1a) to execute: for a production line (10) including a single or a plurality of manufacturing devices and a single or a plurality of inspection devices, in which a manufacturing process and an inspection process of a product by the manufacturing devices and the inspection devices are executed,

a performance value calculation step (S102) of calculating a production performance value that is a performance value of an index related to productivity or quality of the product in the production line; and

a capability value calculation step (S103) of calculating, based on the performance value, a production capability value that is a capability value of an index related to productivity or quality of the product in the production line,

in which the production capability value is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

### DESCRIPTION OF SYMBOLS

1 production management system
1a production management device
10 production line
10a solder printing device
10b post-solder printing inspection device
10c mounter
10d post-mount inspection device
10e reflow furnace
10f post-reflow inspection device
11a data acquisition unit
11b controller
11c storage
11d output unit
110a performance value calculation unit
110b best value calculation unit
110c result report unit

1. A production management system related to a production line including a single or a plurality of manufacturing devices and a single or a plurality of inspection devices, in which a manufacturing process and an inspection process of a product by the manufacturing devices and the inspection devices are executed, the production management system comprising:
a performance value calculation unit configured to calculate a production performance value that is a performance value of an index related to productivity or quality of the product in the production line; and
a capability value calculation unit configured to calculate, based on the performance value, a production capability value that is a capability value of an index related to productivity or quality of the product in the production line,
wherein the production capability value is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

2. The production management system according to claim 1, wherein
the predetermined condition change includes a planned condition change planned in advance for the production line and an accidental condition change accidentally occurring in the production line,
the performance value calculation unit calculates the production performance value by excluding, from data of the index related to productivity or quality of the product in the production line, data of the index corresponding to a statistical outlier in a distribution of the production performance value and affected by the planned condition change in the production line, and
the capability value calculation unit calculates the production capability value by further excluding, from data of the index related to productivity or quality of the product used for calculation of the production performance value, data of the index corresponding to a statistical outlier in a distribution of the production performance value and affected by the accidental condition change in the production line.

3. The production management system according to claim 1, wherein the index related to productivity or quality of the product in the production line includes at least one of a production amount of the product per predetermined time, a manufacturing takt time of the product, and an error rate of the product.

4. The production management system according to claim 1, further comprising a result report unit configured to create a result report capable of comparing the production performance value and the production capability value in a predetermined period.

5. The production management system according to claim 2, further comprising a result report unit configured to create a result report capable of comparing the production performance value and the production capability value in a predetermined period,
wherein the result report unit reports contents of the accidental condition change related to the data of the index excluded when the capability value calculation unit calculates the production capability value.

6. A production management method in a production line including a single or a plurality of manufacturing devices and a single or a plurality of inspection devices, in which a manufacturing process and an inspection process of a product by the manufacturing devices and the inspection devices are executed, the production management method comprising:
a performance value calculation process of calculating a production performance value that is a performance value of an index related to productivity or quality of the product in the production line; and
a capability value calculation process of calculating, based on the performance value, a production capability value that is a capability value of an index related to productivity or quality of the product in the production line,
wherein the production capability value is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

7. The production management method according to claim 6, wherein
the predetermined condition change includes a planned condition change planned in advance for the production line and an accidental condition change accidentally occurring in the production line,
the performance value calculation process includes calculating the production performance value by excluding, from data of the index related to productivity or quality of the product in the production line, data of the index corresponding to a statistical outlier in a distribution of the production performance value and affected by the planned condition change in the production line, and
the capability value calculation process includes calculating the production capability value by further excluding, from data of the index related to productivity or quality of the product used for calculation of the production performance value, data of the index corresponding to a statistical outlier in a distribution of the production performance value and affected by the accidental condition change in the production line.

8. The production management method according to claim 6, wherein the index related to productivity or quality of the product in the production line includes at least one of a production amount of the product per predetermined time, a manufacturing takt time of the product, and an error rate of the product.

9. The production management method according to claim 6, further comprising a result report process of creating a result report capable of comparing the production performance value and the production capability value.

10. The production management method according to claim 7, further comprising a result report process of creating a result report capable of comparing the production performance value and the production capability value,
wherein the result report process includes reporting contents of the accidental condition change related to the data of the index excluded when the production capability value is calculated in the capability value calculation process.

11. A non-transitory computer readable medium storing a program for causing a computer to execute: for a production line including a single or a plurality of manufacturing devices and a single or a plurality of inspection devices, in which a manufacturing process and an inspection process of a product by the manufacturing devices and the inspection devices are executed,
a performance value calculation step of calculating a production performance value that is a performance value of an index related to productivity or quality of the product in the production line; and
a capability value calculation step of calculating, based on the performance value, a production capability value that is a capability value of an index related to productivity or quality of the product in the production line,
wherein the production capability value is an index related to productivity or quality of the product, the production capability value being calculated by excluding, from data of the index related to productivity or quality of the product in the production line, data of the index corresponding to a statistical outlier in a distribution of the production performance value and/or data of the index affected by a predetermined condition change in the production line.

12. The non-transitory computer readable medium storing a program according to claim 11, wherein
the predetermined condition change includes a planned condition change planned in advance for the production line and an accidental condition change accidentally occurring in the production line,
the performance value calculation step includes calculating the production performance value by excluding, from data of the index related to productivity or quality of the product in the production line, data of the index corresponding to a statistical outlier in a distribution of the production performance value and affected by the planned condition change in the production line, and
the capability value calculation step includes calculating the production capability value by further excluding, from data of the index related to productivity or quality of the product used for calculation of the production performance value, data of the index corresponding to a statistical outlier in a distribution of the production performance value and affected by the accidental condition change in the production line.
